(19) United States
(12) Patent Application Publication
(10) Pub. No.: US 2015/0026446 A1
(43) Pub. Date: Jan. 22, 2015

(54) SIGNAL PROCESSING DEVICE AND METHOD FOR INITIALIZING THE SAME

(71) Applicant: KOREA RESEARCH INSTITUTE OF STANDARDS AND SCIENCE, Daejeon (KR)

(72) Inventors: Jinmok KIM, Daejeon (KR); Hyukchan KWON, Daejeon (KR); Yongho LEE, Daejeon (KR); Ki Woong KIM, Daejeon (KR); Kwonkyu YU, Daejeon (KR)

(73) Assignee: KOREA RESEARCH INSTITUTE OF STANDARDS AND SCIENCE, Daejeon (KR)

(21) Appl. No.: 14/324,472

(22) Filed: Jul. 7, 2014

(30) Foreign Application Priority Data
Jul. 19, 2013 (KR) 10-2013-0085593

(51) Int. Cl. G06F 1/24; G06F 9/44; G06F 1/04

(52) U.S. Cl. CPC G06F 1/24; G06F 1/04; G06F 9/4401
USPC 713/1

(57) ABSTRACT

Provided is a signal processing device including: a digital signal detector outputting an inputted serial digital signal; a clock signal generator generating a clock signal on the basis of the serial digital signal; a chip selection signal generator generating a chip selection signal for selecting a chip by using at least one signal of the clock signal and the serial digital signal; and an initializer detecting an initializing signal included in the serial digital signal and generates a reset signal for initializing an operation of the clock signal generator and the chip selection signal generator on the basis of the initializing signal.

### CROSS-REFERENCE TO RELATED APPLICATIONS

This U.S. non-provisional patent application claims priority under 35 U.S.C. §119 of Korean Patent Application No. 10-2013-0085593, filed on Jul. 19, 2013, the entire contents of which are hereby incorporated by reference.

### BACKGROUND OF THE INVENTION

The present invention disclosed herein relates to a data processing system, and more particularly, to a signal processing device preventing a rebooting operation due to the introduction of a noise signal during processing of a serial digital signal.

Digital signals for controlling a control target device (for example, a plurality of sensors) may be generated through a computer. Such digital signals are converted into serial digital signals for transmission and transmitted through transmission lines such as optical cables.

A signal processing device between such a transmission line and a control target device receives a serial data signal that a computer is to transmit. However, before a serial data signal that a computer transmits actually, a noise signal may be introduced into a signal processing device.

A signal processing device receiving such a noise signal recognizes a noise signal as a normal serial data signal and thus performs an abnormal signal processing operation. In order to prevent this, after stabilizing a computer by driving the power of a computer, the power of a signal processing device and a control target device is driven. However, due to an operation of software other than software generating a serial digital signal, a noise signal may be introduced into a computer through an optical cable and a noise signal may be introduced into a signal processing device during an interval where the transmission of a serial digital signal stops and thus a signal is not transmitted. After removing an introduced noise signal by rebooting the power of a signal processing device and a control target device, the computer needs to transmit a serial digital signal.

However, if it is difficult to power on a signal processing device and a control target device since they are located in a confined space or when they are located remotely from a computer, a user need to travel a long distance in order for rebooting. As a result, in order to remove an introduced noise signal, it is necessary to restart the power, that is, rebooting.

### SUMMARY OF THE INVENTION

The present invention provides a signal processing device preventing a rebooting operation due to a noise signal introduced to the signal processing device during processing of a serial digital signal and a method for initializing the same.

Embodiments of the present invention provide signal processing devices including: a digital signal detector outputting an inputted serial digital signal; a clock signal generator generating a clock signal on the basis of the serial digital signal; a chip selection signal generator generating a chip selection signal for selecting a chip by using at least one signal of the clock signal and the serial digital signal; and an initializer detecting an initializing signal included in the serial digital signal and generates a reset signal for initializing an operation of the clock signal generator and the chip selection signal generator on the basis of the initializing signal, wherein the initializer includes: a high pulse generator generating a high pulse signal corresponding to a high signal included in the serial digital signal; a low pulse generator generating a low pulse signal corresponding to a low signal included in the serial digital signal; a counter circuit performing a reset operation in response to the low pulse signal and outputting a detect signal when a predetermined number of the high pulse signals are continuous; and a reset signal generator outputting the reset signal that adjusts a pulse width of the detect signal by a predetermined length.

In some embodiments, the initializing signal may be configured with a first interval during which a predetermined number of high signals are continuous and a second interval that is a standby time for initializing the clock signal generator and the chip selection signal generator; and each of the first interval and the second interval may be formed by a time for processing a unit signal configured with N bits (N is an integer).

In other embodiments, the reset signal generator may adjust the reset signal to have the same length as the second interval.

In still other embodiments, the reset signal generator may include: a monostable multivibrator including an input terminal and an output terminal and generating the reset signal; a resistor connected in parallel on the basis of the input terminal; and a capacitor connected to the output terminal and connected in series to the resistor, wherein a contact point of the input terminal and the output terminal may be connected to a contact point of the capacitor and the resistor.

In even other embodiments, the high signal detection unit may include: a first flip flop receiving the serial digital signal through the input terminal and generating the high pulse signal in response to the clock signal inputted through a clock terminal; and a first inverter inverting the high pulse signal and outputting the inverted high pulse signal to a clean terminal of the first flip flop.

In yet other embodiments, the low signal detection unit may include: a second flip flop receiving the serial digital signal through the input terminal and generating the low pulse signal in response to the clock signal inputted through a clock signal; and a second inverter inverting the low pulse signal and outputting the inverted low pulse signal to a clean terminal of the second flip flop.

In further embodiments, the counter circuit may include: an OR gate outputting an OR operation signal obtained by performing an OR operation on a power reset signal, the low signal, and the detect signal; and a counter receiving high pulse signals inputted through a clock terminal, counting a predetermined number of continuous high pulse signals, and receiving an OR operations signal through the clean terminal.

In still further embodiments, the counter circuit may further include an AND gate performing an AND operation on some of a plurality of output terminals of the counter to detect a number corresponding to the pulse length.

In even further embodiments, the counter may generate the detect signal when a counting operation counting the predetermined number of continuous high pulse signals is completed.

In yet further embodiments, the counter may reset the counting operation when the OR operation signal is activated.

In other embodiments of the present invention, provided are methods of initializing a signal processing device, the methods including: counting a high signal from an inputted serial digital signal; detecting a predetermined number of continuous high signals through the counter; and resetting an operation for generating a clock signal for processing a serial digital signal and a chip selection signal for a predetermined time when the high signals are detected

In some embodiments, the methods may further include, when a low signal is detected from the inputted serial digital signal, resetting the count operation.

In other embodiments, the methods may further include receiving an initializing signal including a first interval during which a predetermined number of high signals for an initialization operation are continuous and a second interval for the reset operation.

In still other embodiments, each of the first interval and the second interval may be formed by a time for processing a unit signal configured with N bits (N is an integer).

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a signal processing system according to an embodiment of the present invention;

FIG. 2 is a view illustrating a signal processing device according to an embodiment of the present invention;

FIG. 3 is a signal flowchart illustrating output signals during normal signal transmission in a signal processing device according to an embodiment of the present invention;

FIG. 4 is a signal flowchart illustrating output signals when a signal processing device receives noise of a low signal;

FIG. 5 is a signal flowchart illustrating output signals when an initialization operation is performed after a signal processing device receives noise of one low signal is received according to an embodiment of the present invention;

FIG. 6 is a signal flowchart illustrating output signals during an initialization operation after a signal processing device receives noise of 23 low signals according to an embodiment of the present invention;

FIG. 7 is a signal flowchart illustrating output signals when an initialization operation is performed after a signal processing device receives noise of one high signal is received according to an embodiment of the present invention;

FIG. 8 is a signal flowchart illustrating output signals during an initialization operation after a signal processing device receives noise of 23 high signals according to an embodiment of the present invention; and

FIG. 9 is a signal flowchart illustrating output signals when an initialization operation is performed after a signal processing device receives noise of a mixed low and high signal is received according to an embodiment of the present invention.

### DETAILED DESCRIPTION OF PREFERRED EMBODIMENTS

Hereinafter, embodiments of the present invention will be described in more detail with reference to the accompanying drawings. In the description below, only a necessary part to understand an operation according to the present invention is described and the descriptions of other parts are omitted in order not to unnecessarily obscure subject matters of the present invention.

The present invention provides a signal processing device preventing a rebooting operation due to the introduction of a noise signal while processing a serial digital signal. The signal processing device suggested by the present invention may be applied to various fields receiving and processing a serial digital signal and for example, may be used to receive a control signal for controlling a plurality of Superconducting Quantum Interference Device (SQUID) sensors detecting a bio signal.

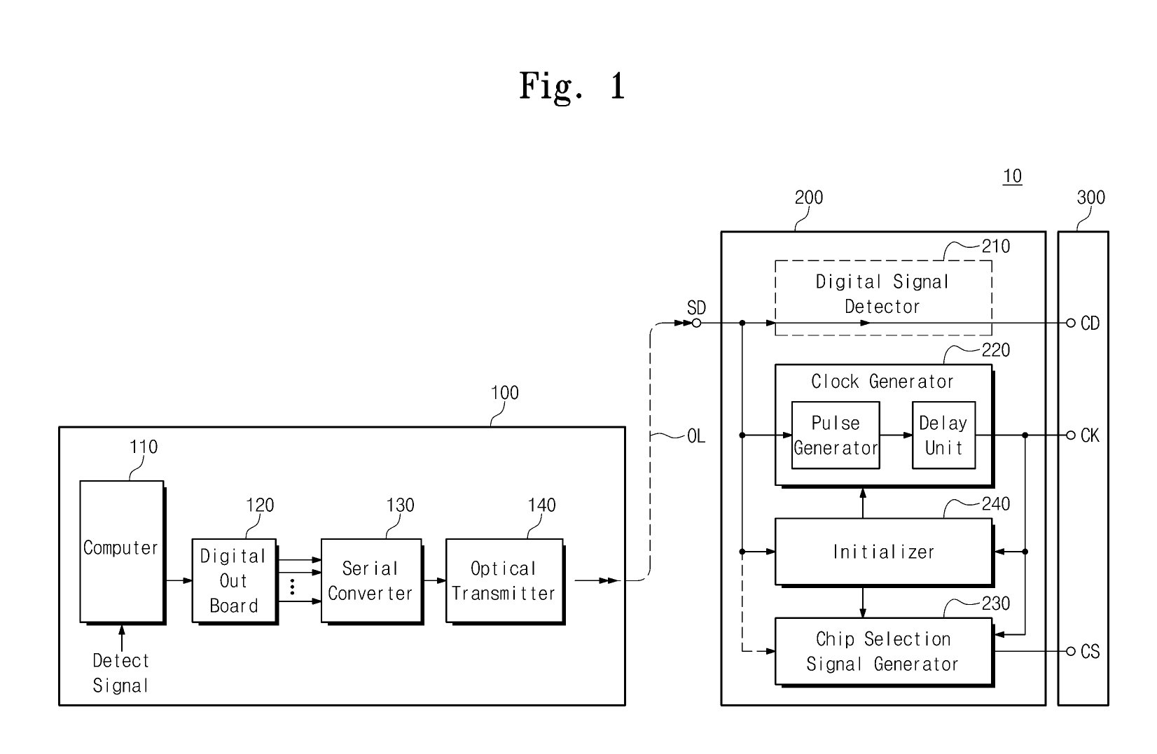

FIG. 1 is a view illustrating a signal processing system according to an embodiment of the present invention.

Referring to FIG. 1, the signal processing system 10 may include a control transmission device 100, a signal processing device 200, and a control target device 300. Here, the control transmission device 100 and the signal processing device 200 are connected through an optical line. Here, the optical line is described exemplarily and various forms of transmission lines other than the optical line may be used for serial digital signal transmission.

The control transmission device 100 includes a computer 110, a digital output board 120, a serial converter 130, and an optical transmitter 140. The control transmission device 100 generates a control signal for controlling a connected control target device (for example, a device including a plurality of channels (or sensors)).

The computer 110 generates a control signal to be transmitted to the control target device 300 connected to the signal processing device 200. A control signal generated from the computer 110 is outputted to a digital output board 120.

The digital output board 120 generates data DT (for example, control data), a clock signal CK, and a chip selection signal CS from a control information signal. The digital output board 120 generates a plurality of digital signals including data DT and a clock signal CK from a control information signal. The digital output board 120 output the plurality of digital signals to the serial converter 130.

The serial converter 130 converts the plurality of digital signals into a serial digital signal SD. The serial converter 130 outputs the serial digital signal SD to the optical transmitter 140.

The optical transmitter 140 converts the serial digital signal SD into an optical signal in order to transmit it to an optical line OL. The optical transmitter 140 outputs the serial digital signal SD to the signal processing device 200 through the connected optical line OL.

The signal processing device 200 may extract a data signal DT, a clock signal CK, and a chip selection signal CS by using the serial digital signal SD received through the optical line OL. The signal processing device 200 includes a digital signal detector 210, a clock signal generator 220, a chip selection signal generator 230, and an initializer 240.

The digital signal detector 210 outputs the inputted serial digital signal SD to the data signal DT.

The clock signal generator 220 receives the serial digital signal SD and generates the clock signal CK. The clock signal generator 220 includes a pulse generator 221 and a delay unit 222.

The pulse generator 221 generates a clock pulse. The pulse generator 221 outputs the generated clock pulse to the delay unit 222.

The delay unit 222 generates a clock signal by delaying the clock pulse during a predetermined time. Here, the control target device 300 may determine a high signal and a low signal by using the generated clock signal. Here, the high signal is a digital signal having a high level and, for example, is a digital signal corresponding to ‘1’. Otherwise, the low signal is a digital signal having a low level and, for example, is a digital signal corresponding to ‘0’.

The clock signal generator 220 outputs a clock signal CK to the chip selection signal generator 230 and the initializer 240.

The chip selection signal generator 230 receives the clock signal CK and generates a chip selection signal CS by using the clock signal CK. Additionally, the chip selection signal generator 230 may generate the chip selection signal CS by using the serial digital signal SD. At this point, the chip selection signal generator 230 may not receive the clock signal CK from the clock signal generator 220. Here, the chip selection signal CS may be used to detect an address of the control target device 300 (that is, a plurality of channels) included in the data signal DT.

The initializer 240 may initialize an operation of the signal processing device 200 without a power rebooting operation. An operation of the initializer 240 is described in more detail below.

The control target device 300 may form a plurality of channels and may control a module (for example, a sensor) corresponding to each of a plurality of channels by using a signal outputted from the signal processing device 200.

The computer 110 suggested by the present invention generates an initializing signal. The initializing signal includes a first interval during which the predetermined number of high signals is continuous and a second interval for standby according to an initialization operation of the signal processing device 200. In the second interval, data is not transmitted in order for an initialization operation of the signal processing device 200.

The computer 110 may include a user interface device for receiving an initializing command from a user. Additionally, the computer 110 may determine an abnormal operation of the signal processing device 200 on the basis of a detect signal (for example, a voltage signal) outputted from the control target device 300.

Accordingly, when a user control signal for initializing the signal processing device 200 is inputted or an abnormal operation is determined from a detect signal, the computer 110 generates an initializing signal. The computer 110 outputs the generated initializing signal to the digital output board 120.

A noise signal from a power on operation of the signal processing device 200 or an operation for transmitting a serial digital signal after the serial digital signal is not transmitted for a predetermined time may be introduced into the signal processing device 200. In order to prevent an abnormal operation of the signal processing device 200 due to such a noise signal, the control transmission device 110 generates an initializing signal and outputs it to the signal processing device 200.

The signal processing device 200 includes the initializer 240 for an initialization operation by using an initializing signal. The initializer 240 receives the serial digital signal SD. The initializer 240 initializes a state of the signal processing device 200 by using an initializing signal included in the serial digital signal SD. That is, when the predetermined number of continuous high signals (for example, a 24-bit continuous high signal) is detected by using an initializing signal, the initializer 240 initializes the clock signal generator 220 and the chip selection signal generator 230.

Through this, when a normal serial digital signal is not detected due to a noise signal in the signal processing device 200, the initializer 240 may initialize the signal processing device 200 without performing an additional power rebooting operation.

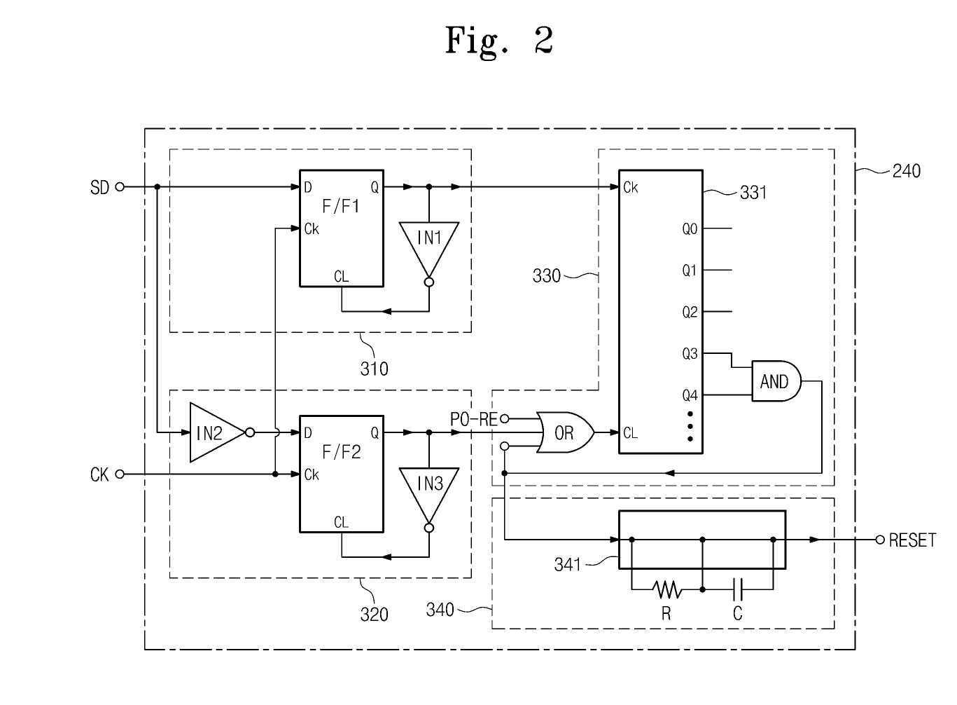

FIG. 2 is a view illustrating a signal processing device according to an embodiment of the present invention.

Referring to FIG. 2, the signal processing device 200 may include a high pulse generator 310, a low pulse generator 320, a counter circuit 330, and a reset signal generator 340.

The high pulse generator 310 detects a high signal by using a serial digital signal SD and a clock signal CK and outputs the detected high signal to the counter circuit 330.

The high pulse generator 310 includes a first flip flop F/F1 and a first inverter IN1.

The first flip flop F/F1 includes an input terminal D, an output terminal Q, a clock terminal Ck and a clean terminal CL. The input terminal D receives the serial digital signal SD and the output terminal Q generates a pulse output by a clock signal CK inputted through the clock terminal Ck and a clean signal inputted through the clean terminal CL.

The first inverter IN1 is connected to the output terminal Q of the first flip flop F/F1. The first inverter IN1 outputs a clean signal inverting the outputted pulse signal to the clean terminal CL of the first flip flop F/F1.

Accordingly, the first flip flop F/F1 generates a high pulse output corresponding to a high signal included in the serial digital signal SD by the first inverter IN1.

The low pulse generator 320 detects a low signal by using the serial digital signal SD and the clock signal CK and outputs the detected low signal to the counter circuit 330.

The low pulse generator 320 includes a second inverter IN2, a second flip flop F/F2, and a first inverter IN2.

The second inverter IN2 inverts the serial digital signal SD and then outputs it to the second flip flop F/F2.

The second flip flop F/F2 includes an input terminal D, an output terminal Q, a clock terminal Ck and a clean terminal CL. The input terminal D receives the inverted serial digital signal SD and the output terminal Q generates a pulse output by a clock signal CK inputted through the clock terminal Ck and a clean signal inputted through the clean terminal CL.

The third inverter IN3 is connected to the output terminal Q of the second flip flop F/F2. The third inverter IN3 outputs a clean signal inverting the outputted pulse signal to the clean terminal CL of the second flip flop F/F2.

Accordingly, the second flip flop F/F2 generates a low pulse output corresponding to a low signal of the serial digital signal SD by the third inverter IN3.

The counter circuit 330 counts a high pulse signal outputted from the high pulse generator 310 and generates a detect signal when the number of continuous high pulse signals is detected.

The counter circuit 330 includes an OR operator OR, a counter 331, and an AND operator AND.

The OR operator OR performs an OR operation on a power reset signal PO_RE, a low pulse signal, and a detect signal. The OR operator OR outputs an OR operation signal to the counter 331.

The counter 331 includes a clock terminal Ck, a clean terminal CL, and a plurality of output terminals Q0, Q1, Q2, Q3, Q4, . . . . The counter 331 outputs a count signal obtained by counting a high pulse signal inputted through the clock terminal Ck. At this point, when an activated or high state OR operation signal is inputted to the clean terminal CL of the counter 331, a count operation is initialized. That is, a counting value of the counter 331 is set to ‘0’.

Accordingly, when a high signal serial digital signal SD is inputted continuously, the counter 331 increases a counting value by each high signal and when a low signal serial digital signal SD is inputted, the counter 331 initializes the counting value. Or, when the power reset signal PO_RE is inputted, the counter 331 initializes a counting value and when a detect signal is generated by the counter 331, the counter 331 initializes a counting value.

When counting an N bit high pulse signal, for example, a 24 bit high pulse signal, is completed, the counter 331 outputs a high signal from each of a fourth output terminal Q3 and a fifth output terminal Q4 to the AND operator AND.

The AND operator AND performs an AND operation on output signals of the fourth output terminal Q3 and the fifth output terminal Q4. Therefore, when a high signal is outputted from the fourth output terminal Q3 and the fifth output terminal Q4, the AND operator AND generates a detect signal.

Here, the case in which the AND operator AND detects a 24 bit high signal is described as one example but when a different number of bits is detected, other output terminals may be connected. For example, when 32 bits are detected, since a signal of the sixth output terminal Q5 becomes a detect signal, in this case, the AND operator AND may not be included.

The AND operator AND outputs the detected detect signal to the OR operator OR and a reset signal generator 340.

The reset signal generator 340 generates a reset signal RESET to initialize an operation of the clock signal generator 220 and the chip selection signal generator 230 by an initializing signal.

The reset signal generator 340 includes a monostable multivibrator 341, a resistor R, and a capacitor C.

The monostable multivibrator 341 generates a reset signal by changing a pulse width of a detect signal through the resistor R and the capacitor C connected in parallel.

The resistor R is connected in parallel to the input terminal of the monostable multivibrator 341.

The capacitor C is connected in series to the resistor R and is connected in parallel to the output terminal of the monostable multivibrator 341.

OR, a contact point of the resistor R and the capacitor C is connected to a node between the input terminal and the output terminal of the monostable multivibrator 341.

The monostable multivibrator 341 outputs a reset signal changing a pulse width to each of the clock signal generator 220 and the chip selection signal generator 230. Here, the reset signal my have a time length corresponding to N bits. At this point, the clock signal generator 220 and the chip selection signal generator 230 performs an initialization maintenance (standby) operation by a reset signal for a time for processing a one unit signal, for example, N (N is an integer) bits (for example, 24 bits).

Accordingly, the reset signal may be implemented in a one-pulse form having a predetermined time width (for example, set to be equal to or greater than a time during which an N bit digital signal is inputted).

Upon the receipt of an initializing signal including an N bit high signal, the signal processing device 200 may initialize an operation of the clock signal generator 220 and the chip signal generator 230.

While the clock signal generator 220 and the chip signal generator 230 maintains an initialization operation state, the serial digital signal SD received through an optical cable is not transmitted to the control target device 300.

When a normal signal is received after the operation initialization of the clock signal generator 220 and the chip signal generator 230, the signal processing device 200 may remove a noise signal received before an initializing signal. Through this, the signal processing device 200 may transmit normal data, a clock signal, and a chip selection signal to the control target device 300.

Through this, the signal processing device 200 may initialize its operation without performing a rebooting operation due to the introduction of a noise signal.

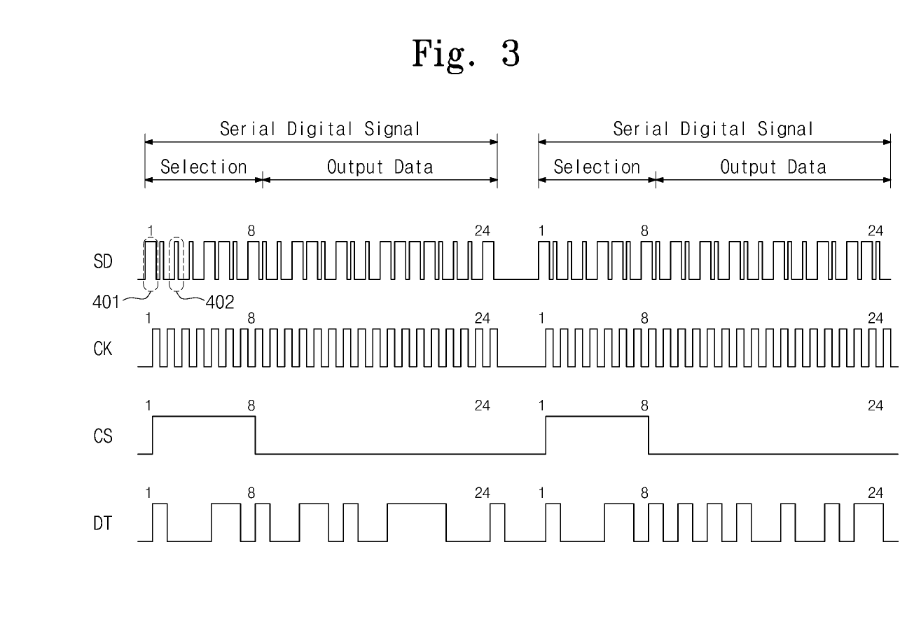

FIG. 3 is a signal flowchart illustrating output signals during normal signal transmission in a signal processing device according to an embodiment of the present invention.

Referring to FIG. 3, a serial digital signal SD, a clock signal CK, a chip selection signal CS, and a data signal DT are shown.

In relation to the serial digital signal SD, a 24 bit serial digital signal is one unit signal and two unit signals are inputted to the signal processing device 200 through an optical cable. At this point, the normal serial digital signal SD is inputted to the signal processing device 200 without the introduction of a normal signal. Here, the unit signal is configured with 24 bits, for example.

The serial digital signal SD inputted to the signal processing device 200 may be configured with a high signal 401 and a low signal 402. Additionally, one unit signal configured with 24 bits includes 8 bit chip selection information (for example, channel information or address information) and 16 bit data (for example, output voltage information).

The signal processing device 200 generates a clock signal CK and a chip selection signal CS by using the serial digital signal SD.

The clock signal CK includes 24 clock pulses while one unit serial digital signal is received to detect a 24 bit serial digital signal.

Or, the chip selection signal CS is activated while 8 bit data is received based on an initially inputted serial digital signal and deactivated while the remaining 16 bit data is received.

The data DT is data extracted by using a clock signal.

In such a way, if a noise signal is not inputted, the signal processing device 200 may generate a normal clock signal CK and chip selection signal CS. Through this, it is possible to detect normal data DT.

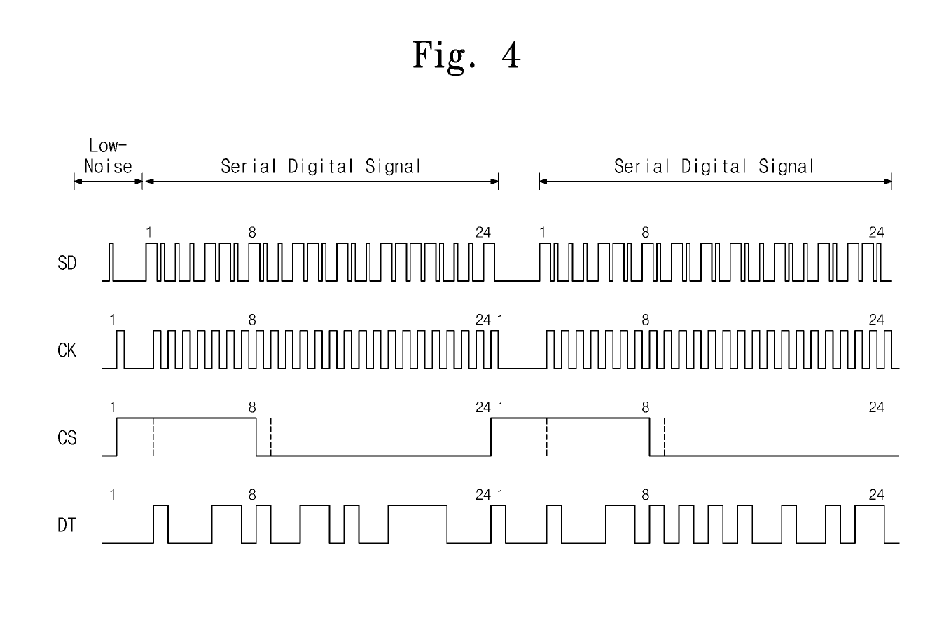

FIG. 4 is a signal flowchart illustrating output signals when a signal processing device receives noise of a low signal.

Referring to FIG. 4, a serial digital signal SD, a clock signal CK, a chip selection signal CS, and a data signal DT are shown.

In relation to the serial digital signal SD, a 24 bit serial digital signal is one unit signal and two unit signals are inputted to the signal processing device 200 through an optical cable. At this point, the signal processing device 200 receives noise of one low signal before receiving a normal serial digital signal SD.

At this point, the signal processing device 200 generates a clock signal CK and a chip selection signal CS by a noise signal (i.e., a low signal).

The chip selection signal CS is activated while the normal serial digital signal SD of the seventh bit is received on the basis of an initially inputted noise signal. Accordingly, when the seventh bit of the normal serial digital signal SD is inputted completely, the chip selection signal CS becomes deactivated.

Additionally, a normal chip selection signal CS is indicated by a dotted line when a noise signal is not inputted.

Due to this, the signal processing device 200 uses invalid 8 bit chip selection information and 16 bit data. Accordingly, it is impossible to detect normal data. Additionally, the signal processing device 200 determines the last bit included in the first unit signal before the second unit signal is inputted, as the start bit of the second unit signal.

Accordingly, the signal processing device 200 generates an invalid clock signal CK and chip selection signal CS for the next unit signal. Another channel may respond in the control target device 300 by the chip selection signal CS operating faster by one bit and the control target device 300 may generate an abnormal output voltage.

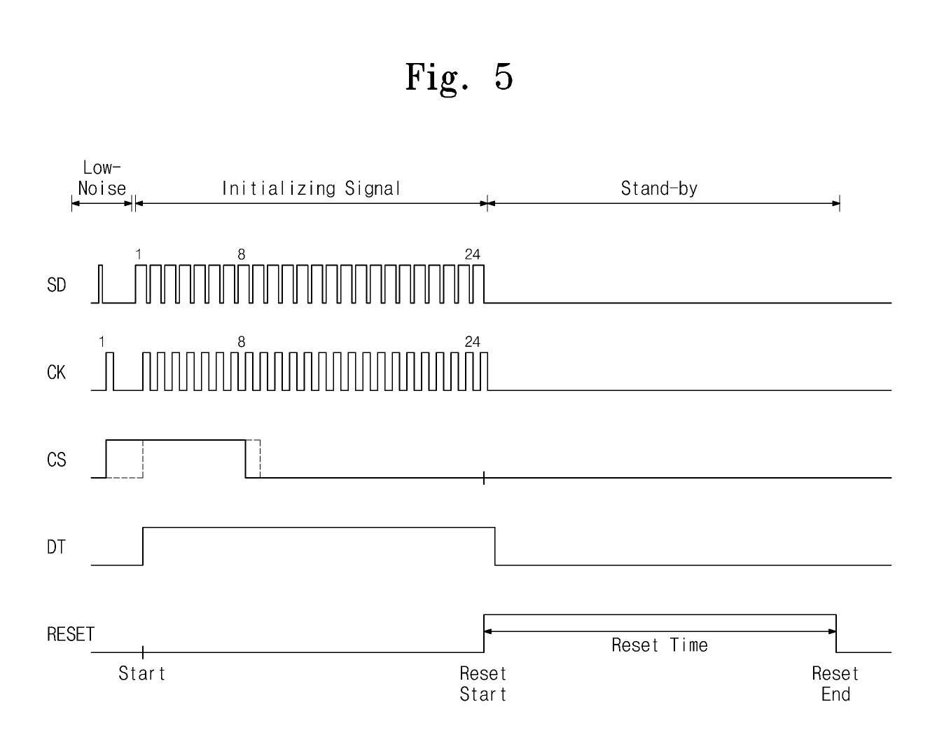

FIG. 5 is a signal flowchart illustrating output signals when an initialization operation is performed after a signal processing device receives noise of one low signal is received according to an embodiment of the present invention.

Referring to FIG. 5, a serial digital signal SD, a clock signal CK, a chip selection signal CS, a data signal DT, and a reset signal RESET are shown.

In relation to the serial digital signal SD, a 24 bit serial digital signal is one unit signal and an initializing signal is inputted to the signal processing device 200 through an optical cable. At this point, the signal processing device 200 receives noise of one low signal before receiving a normal serial digital signal SD.

At this point, the signal processing device 200 generates a clock signal CK and a chip selection signal CS by a noise signal (i.e., a low signal).

The chip selection signal CS is activated while the normal serial digital signal SD of the seventh bit is received on the basis of an initially inputted noise signal. Accordingly, when the seventh bit of the normal serial digital signal SD is inputted completely, the chip selection signal CS becomes deactivated.

Additionally, a normal chip selection signal CS is indicated by a dotted line when a noise signal is not inputted.

However, the initializer 240 in the signal processing device 200 counts 24 high signals included in the serial digital signal SD.

When a counting operation is completed in the initializer 240, a reset signal RESET for initializing the clock signal generator 220 and the chip selection signal generator 230 is generated.

Through this, the reset signal RESET is activated when the last high signal of an initializing signal is inputted completely and is deactivated after a predetermined reset time elapses. For example, the reset time is generated to be greater than a length of a unit signal (for example, 24 bits).

Accordingly, the control target device 300 connected to the signal processing device 200 may normally receive the serial digital signal SD received from the computer 110 after an initialization operation.

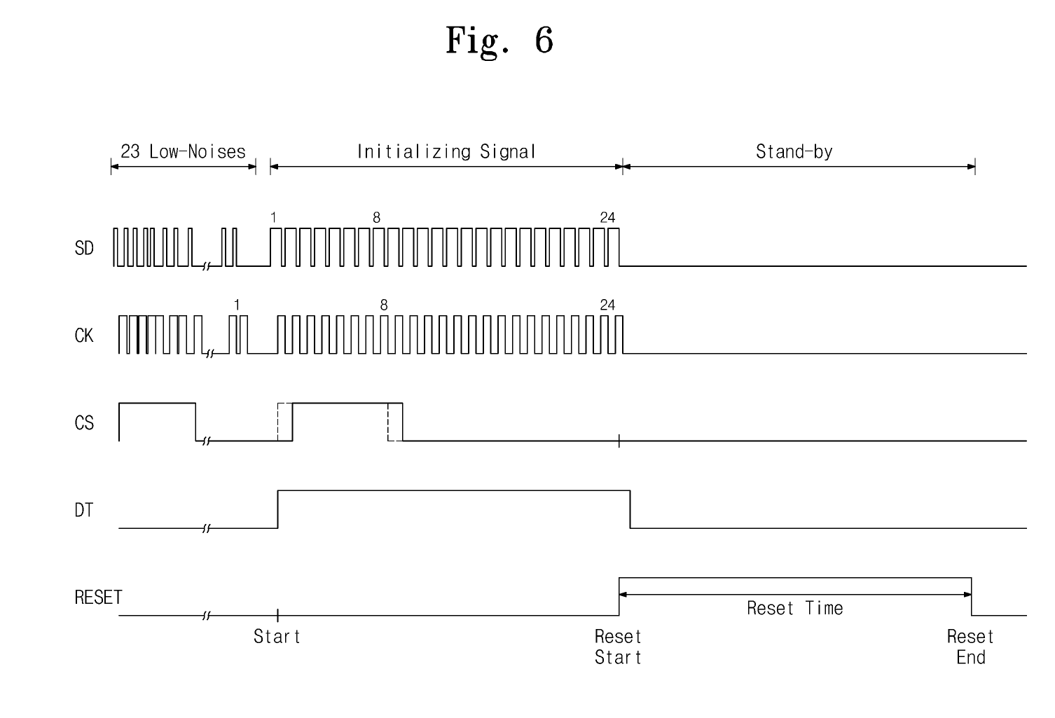

FIG. 6 is a signal flowchart illustrating output signals during an initialization operation after a signal processing device receives noise of 23 low signals according to an embodiment of the present invention.

Referring to FIG. 6, a serial digital signal SD, a clock signal CK, a chip selection signal CS, a data signal DT, and a reset signal RESET are shown.

In relation to the serial digital signal SD, a 24 bit serial digital signal is one unit signal and an initializing signal is inputted to the signal processing device 200 through an optical cable. At this point, the signal processing device 200 receives noise of a plurality of low signals (for example, 23 low signals) before receiving a normal serial digital signal SD.

At this point, the signal processing device 200 generates a clock signal CK and a chip selection signal CS by a noise signal (i.e., a plurality of low signals).

The chip selection signal CS is activated while eight noise signals are received on the basis of an initially inputted noise signal. Then, the chip selection signal CS is activated when the second bit of the normal serial digital signal SD is inputted completely and is deactivated when the ninth bit of the normal serial digital signal SD is inputted completely. That is, when the ninth bit of the normal serial digital signal SD is inputted completely, the chip selection signal CS becomes deactivated.

Additionally, a normal chip selection signal CS is indicated by a dotted line when a noise signal is not inputted.

However, the initializer 240 in the signal processing device 200 counts 24 high signals included in the serial digital signal SD.

When a counting operation is completed in the initializer 240, a reset signal RESET for initializing the clock signal generator 220 and the chip selection signal generator 230 is generated.

Through this, the reset signal RESET is activated when the last high signal of the initializing signal is inputted completely and is deactivated after a predetermined reset time elapses. For example, the reset time is generated to be greater than a length of a unit signal (for example, 24 bits).

Accordingly, the control target device 300 connected to the signal processing device 200 may normally receive the serial digital signal SD received from the computer 110 after an initialization operation.

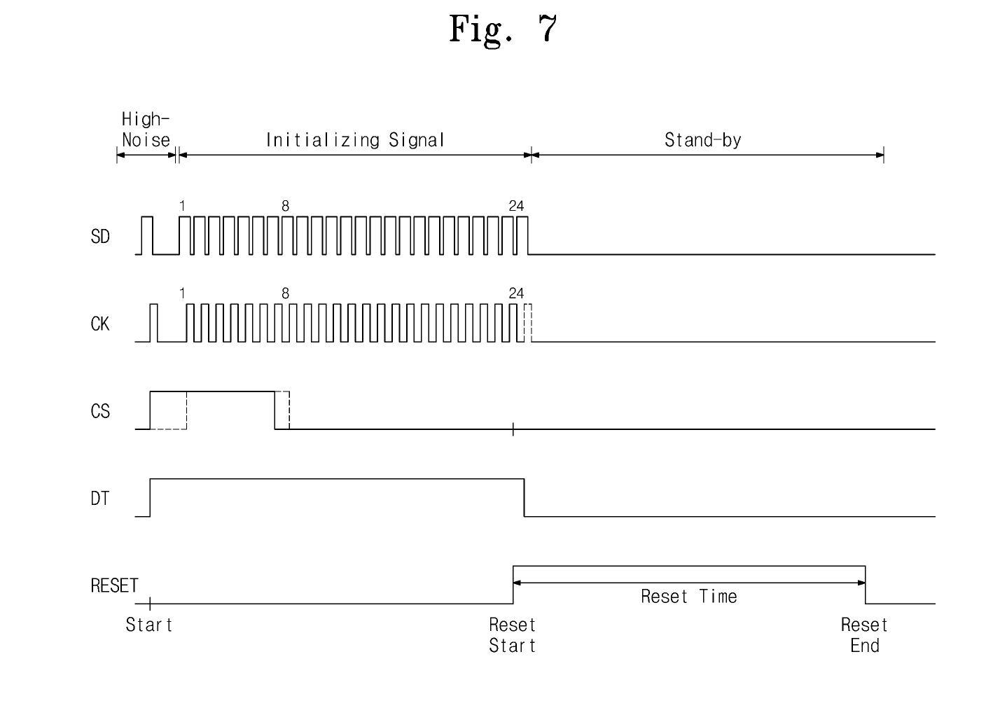

FIG. 7 is a signal flowchart illustrating output signals when an initialization operation is performed after a signal processing device receives noise of one high signal is received according to an embodiment of the present invention.

Referring to FIG. 7, a serial digital signal SD, a clock signal CK, a chip selection signal CS, a data signal DT, and a reset signal RESET are shown.

In relation to the serial digital signal SD, a 24 bit serial digital signal is one unit signal and an initializing signal is inputted to the signal processing device 200 through an optical cable. At this point, the signal processing device 200 receives noise of one high signal before receiving a normal serial digital signal SD.

At this point, the signal processing device 200 generates a clock signal CK and a chip selection signal CS by a noise signal (i.e., a high signal).

The chip selection signal CS is activated while the normal serial digital signal SD of the seventh bit is received on the basis of an initially inputted noise signal. Accordingly, when the seventh bit of the normal serial digital SD is inputted completely, the chip selection signal CS becomes deactivated.

Additionally, a normal chip selection signal CS is indicated by a dotted line when a noise signal is not inputted.

However, the initializer 240 in the signal processing device 200 counts one noise signal and 23 high signals included in the serial digital signal SD.

When a counting operation is completed in the initializer 240, a reset signal RESET for initializing the clock signal generator 220 and the chip selection signal generator 230 is generated.

Through this, the reset signal RESET is activated when the 23th high signal of the initializing signal is inputted completely and is deactivated after a predetermined reset time elapses. For example, the reset time is generated to be greater than a length of a unit signal (for example, 24 bits).

Accordingly, the control target device 300 connected to the signal processing device 200 may normally receive the serial digital signal SD received from the computer 110 after an initialization operation.

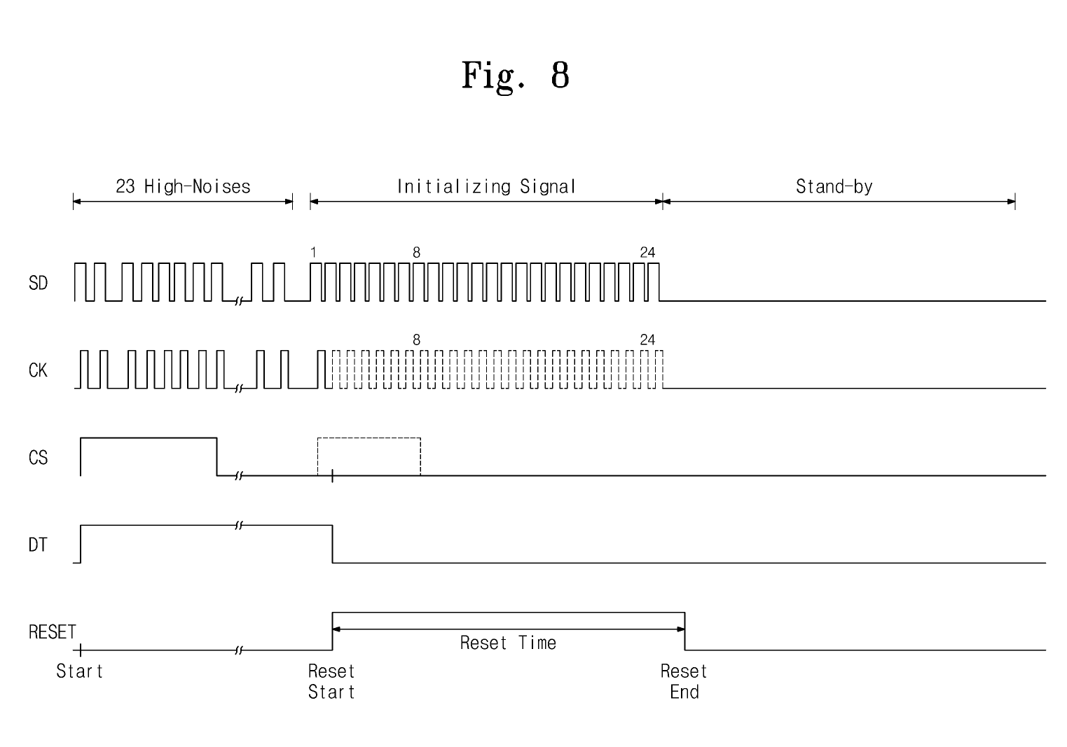

FIG. 8 is a signal flowchart illustrating output signals during an initialization operation after a signal processing device receives noise of 23 high signals according to an embodiment of the present invention.

Referring to FIG. 8, a serial digital signal SD, a clock signal CK, a chip selection signal CS, a data signal DT, and a reset signal RESET are shown.

In relation to the serial digital signal SD, a 24 bit serial digital signal is one unit signal and an initializing signal is inputted to the signal processing device 200 through an optical cable. At this point, the signal processing device 200 receives noise of a plurality of high signals (for example, 23 high signals) before receiving a normal serial digital signal SD. Here, the unit signal is configured with 24 bits, for example.

At this point, the signal processing device 200 generates a clock signal CK and a chip selection signal CS by a noise signal (i.e., a plurality of high signals).

The chip selection signal CS is activated while eight noise signals are received on the basis of an initially inputted noise signal. Accordingly, when the ninth bit of the noise signal is inputted completely, the chip selection signal CS becomes deactivated. Then, in relation to the chip selection signal CS, 23 noise signals and one initializing signal are regarded as an initializing signal and processed in the signal processing device 200. Accordingly, the chip selection signal CS is not generated from the signal processing device 200 while the initializing signal is inputted.

Additionally, a normal chip selection signal CS is indicated by a dotted line when a noise signal is not inputted.

However, the initializer 240 in the signal processing device 200 counts 23 noise signals and one high signal included in the serial digital signal SD.

When a counting operation is completed in the initializer 240, a reset signal RESET for initializing the clock signal generator 220 and the chip selection signal generator 230 is generated.

Through this, the reset signal RESET is activated when the first high signal of the initializing signal is inputted completely and is deactivated after a predetermined reset time elapses. For example, the reset time is generated to be greater than a length of a unit signal (for example, 24 bits).

Accordingly, the control target device 300 connected to the signal processing device 200 may normally receive the serial digital signal SD received from the computer 110 after an initialization operation.

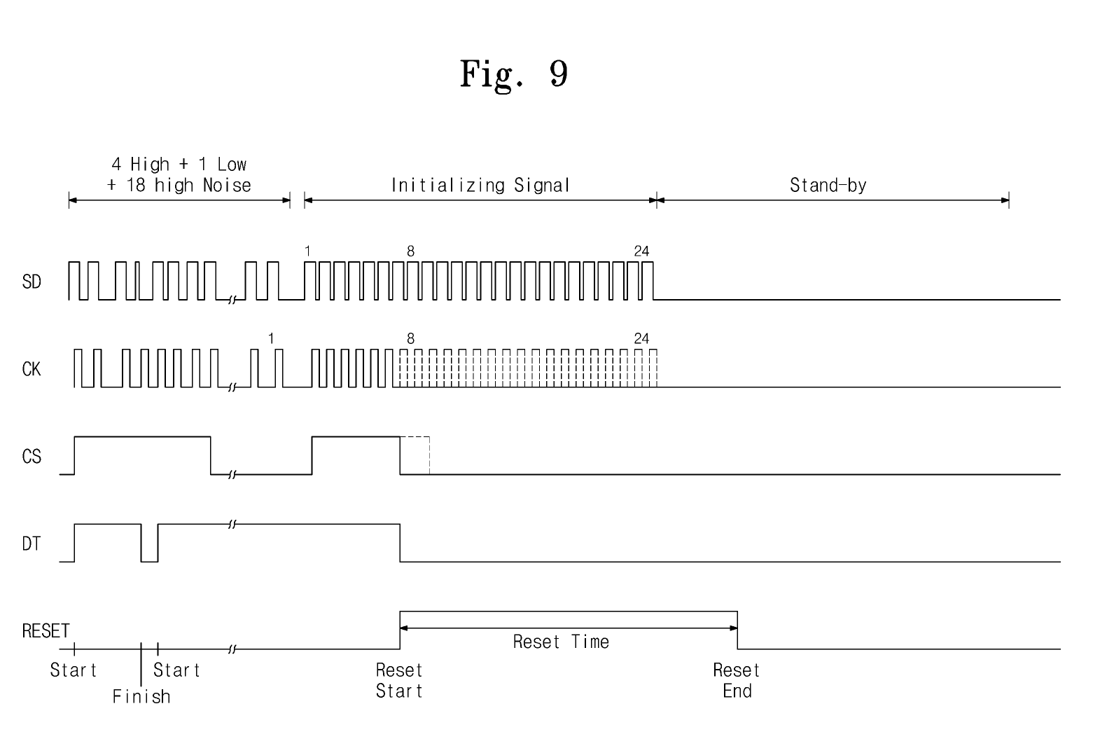

FIG. 9 is a signal flowchart illustrating output signals when an initialization operation is performed after a signal processing device receives noise of a mixed low and high signal is received according to an embodiment of the present invention.

Referring to FIG. 9, a serial digital signal SD, a clock signal CK, a chip selection signal CS, a data signal DT, and a reset signal RESET are shown.

In relation to the serial digital signal SD, a 24 bit serial digital signal is one unit signal and an initializing signal is inputted to the signal processing device 200 through an optical cable. At this point, the signal processing device 200 receives noise of mixed high signals and low signals (for example, four high signals+one low signal+18 high signals) before receiving a normal serial digital signal SD. Here, the unit signal is configured with 24 bits, for example.

At this point, the signal processing device 200 generates a clock signal CK and a chip selection signal CS by a noise signal (i.e., a plurality of high signals and low signals).

The chip selection signal CS is activated while eight noise signals are received on the basis of an initially inputted noise signal. Then, in relation to the chip selection signal CS, 18 noise signals after a low signal and six initializing signals are regarded as an initializing signal and processed in the signal processing device 200.

Additionally, a normal chip selection signal CS is indicated by a dotted line when a noise signal is not inputted.

However, the initializer 240 in the signal processing device 200 counts 18 noise signals after a low signal and six high signals included in the serial digital signal SD.

When a counting operation is completed in the initializer 240, a reset signal RESET for initializing the clock signal generator 220 and the chip selection signal generator 230 is generated.

Through this, the reset signal RESET is activated when the sixth high signal of the initializing signal is inputted completely and is deactivated after a predetermined reset time elapses. For example, the reset time is generated to be greater than a length of a unit signal (for example, 24 bits).

Additionally, an end time of a counting operation and a restart time of a counting operation in the initializer 240 are shown in an interval for receiving a noise signal.

Accordingly, the control target device 300 connected to the signal processing device 200 may normally receive the serial digital signal SD received from the computer 110 after an initialization operation.

When the signal processing device 200 malfunctions due to digital noise introduction during an initial operation or an operation of a data processing system, without rebooting the signal processing device 200 or the control target device 300 connected to the signal processing device 200, the signal processing device 200 may be simply initialized by an initializing signal of a computer. Through this, the signal processing device 200 may provide a serial digital signal stably to the control target device 300.

Accordingly, even when it is difficult to restart the power supply because the signal processing device 200 is located remotely from a computer or is located in a confined space, malfunction may be prevented by initializing the signal processing device 200.

Additionally, the signal processing device 200 may be initialized easily without a standby time until stabilized according to power rebooting of a signal processing device.

The signal processing device suggested by the present invention may be used to receive a control signal for voltage control from a computer through a plurality of channels in medical diagnostic equipment using Superconducting Quantum Interference Device (SQUID) sensor. Here, the SQID sensor includes a sensor for measuring Magnetocardiography (MCG), Magnetoencephalography (MEG), Electrocardiography (ECG), and Electroencephalography (EEG).

However, the present invention may expand and thus may be applied to an initialization operation of a signal processing device receiving a serial digital signal besides such medical diagnostic equipment.

According to an embodiment of the present invention, without rebooting a signal processing device due to a noise signal, the signal processing device may be initialized through an initializer capable of performing an initialization operation in response to an initializing signal transmitted from a computer.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A signal processing device comprising:
a digital signal detector outputting an inputted serial digital signal;
a clock signal generator generating a clock signal on the basis of the serial digital signal;
a chip selection signal generator generating a chip selection signal for selecting a chip by using at least one signal of the clock signal and the serial digital signal; and
an initializer detecting an initializing signal included in the serial digital signal and generates a reset signal for initializing an operation of the clock signal generator and the chip selection signal generator on the basis of the initializing signal,
wherein the initializer comprises:
a high pulse generator generating a high pulse signal corresponding to a high signal included in the serial digital signal;
a low pulse generator generating a low pulse signal corresponding to a low signal included in the serial digital signal;
a counter circuit performing a reset operation in response to the low pulse signal and outputting a detect signal when a predetermined number of the high pulse signals are continuous; and
a reset signal generator outputting the reset signal that adjusts a pulse width of the detect signal by a predetermined length.

2. The device of claim 1, wherein
the initializing signal is configured with a first interval during which a predetermined number of high signals are continuous and a second interval that is a standby time for initializing the clock signal generator and the chip selection signal generator; and
each of the first interval and the second interval is formed by a time for processing a unit signal configured with N bits (N is an integer).

3. The device of claim 2, wherein the reset signal generator adjusts the reset signal to have the same length as the second interval.

4. The device of claim 1, wherein the reset signal generator comprises:
a monostable multivibrator including an input terminal and an output terminal and generating the reset signal;
a resistor connected in parallel on the basis of the input terminal; and
a capacitor connected to the output terminal and connected in series to the resistor,
wherein a contact point of the input terminal and the output terminal is connected to a contact point of the capacitor and the resistor.

5. The device of claim 1, wherein the high signal detection unit comprises:
a first flip flop receiving the serial digital signal through the input terminal and generating the high pulse signal in response to the clock signal inputted through a clock terminal; and
a first inverter inverting the high pulse signal and outputting the inverted high pulse signal to a clean terminal of the first flip flop.

6. The device of claim 5, wherein the low signal detection unit comprises:
a second flip flop receiving the serial digital signal through the input terminal and generating the low pulse signal in response to the clock signal inputted through a clock signal; and
a second inverter inverting the low pulse signal and outputting the inverted low pulse signal to a clean terminal of the second flip flop.

7. The device of claim 6, wherein the counter circuit comprises:
an OR gate outputting an OR operation signal obtained by performing an OR operation on a power reset signal, the low signal, and the detect signal; and
a counter receiving high pulse signals inputted through a clock terminal, counting a predetermined number of continuous high pulse signals, and receiving an OR operations signal through the clean terminal.

8. The device of claim 7, wherein the counter circuit further comprises an AND gate performing an AND operation on some of a plurality of output terminals of the counter to detect a number corresponding to the pulse length.

9. The device of claim 8, wherein the counter generates the detect signal when a counting operation counting the predetermined number of continuous high pulse signals is completed.

10. The device of claim 9, wherein the counter resets the counting operation when the OR operation signal is activated.

11. A method of initializing a signal processing device, the method comprising:
counting a high signal from an inputted serial digital signal;
detecting a predetermined number of continuous high signals through the counter; and
resetting an operation for generating a clock signal for processing a serial digital signal and a chip selection signal for a predetermined time when the high signals are detected

12. The method of claim 11, further comprising, when a low signal is detected from the inputted serial digital signal, resetting the count operation.

13. The method of claim 11, further comprising receiving an initializing signal including a first interval during which a predetermined number of high signals for an initialization operation are continuous and a second interval for the reset operation.

14. The method of claim 11, wherein each of the first interval and the second interval is formed by a time for processing a unit signal configured with N bits (N is an integer).
